(19) United States
(12) Patent Application Publication
(10) Pub. No.: US 2012/0166381 A1
(43) Pub. Date: Jun. 28, 2012

(54) APPARATUS AND METHOD FOR DETECTING RISKY SITUATIONS

(75) Inventors: Geonwoo KIM, Daejeon (KR); Young-Giu JUNG, Daejeon (KR); SuGil CHOI, Daejeon (KR); Jin Hee HAN, Daejeon (KR); Hong IL JU, Daejeon (KR); Min-ho HAN, Daejeon (KR); Su Wan PARK, Daejeon (KR); Yong-Sung JEON, Daejeon (KR); Moo Seop KIM, Daejeon (KR); Young Sae KIM, Daejeon (KR); Jong-Wook HAN, Daejeon (KR)

(73) Assignee: Electronics and Telecommunications Research Institute, Daejeon (KR)

(21) Appl. No.: 13/298,763

(22) Filed: Nov. 17, 2011

(30) Foreign Application Priority Data
Dec. 23, 2010 (KR) 10-2010-0133145

(51) Int. Cl. G06N 5/02

(52) U.S. Cl. 706/52

(57) ABSTRACT

An apparatus for detecting risky situations includes a detection unit for detecting a risky situation and reporting the detected risky situation, and a control unit for analyzing and assessing the risky situation reported from the detection unit to take measures to the assessed risky situation.

### CROSS-REFERENCE TO RELATED APPLICATION(S)

The present invention claims priority of Korean Patent Application No. 10-2010-0133145, filed on Dec. 23, 2010, which is incorporated herein by reference.

### FIELD OF THE INVENTION

The present invention relates to a technology for detecting risky situations, and more particularly, to an apparatus and method for detecting risky situations to take efficient measures to emergencies by analyzing risky situations and collecting more details about the risky situations in real time.

### BACKGROUND OF THE INVENTION

Typically, existing detection of an risky situation involves not automatically detecting an risky but analyzing manually collected data, e.g., collected images to detect an risky situation and take measures to the detected risky situation. For example, administrators themselves monitor images collected by CCTVs or the like installed in public places, recognize risky situations and assess the risky situations.

However, this typical way of detecting an risky situation is problematic in that every detection process is manually done in most cases, and hence the accuracy of detection of risky situations is rather low and a detection result of the risky situations differs depending on the proficiency of the image administrator or the criteria for assessment by the image administrator. Moreover, the ways of using CCTVs have the problem that a risky situation cannot be detected in places where no CCTVs are installed.

### SUMMARY OF THE INVENTION

In view of the above, the present invention provides an apparatus and method for detecting risky situations to take efficient measures to emergencies by analyzing risky situations and collecting more details about the risky situations in real time.

In accordance with an aspect of the present invention, there is provided an apparatus for detecting risky situations, the apparatus including:

a detection unit for detecting a risky situation and reporting the detected risky situation; and

a control unit for analyzing and assessing the risky situation reported from the detection unit to take measures to the assessed risky situation.

In accordance with another aspect of the present invention, there is provided a method for detecting risky situations, the method including:

detecting an risky situation;

analyzing and assessing the detected risky situation; and

taking measures to the assessed risky situation.

### BRIEF DESCRIPTION OF THE DRAWINGS

The above and other objects and features of the present invention will become apparent to those skilled in the art from the following description of embodiments, given in conjunction with the accompanying drawings, in which:

FIG. 1 shows a block diagram of an apparatus for detecting risky situations in accordance with an embodiment of the present invention; and

FIG. 2 illustrates a flowchart for explaining a method for detecting risky situations in accordance with an embodiment of the present invention.

### DETAILED DESCRIPTION OF THE EMBODIMENTS

The advantages and features of the present invention will be clearly understood from the following embodiments taken in conjunction with the accompanying drawings, so that they can be readily implemented by those skilled in the art. In the drawings, like or similar reference numerals denote like or similar elements throughout the specification.

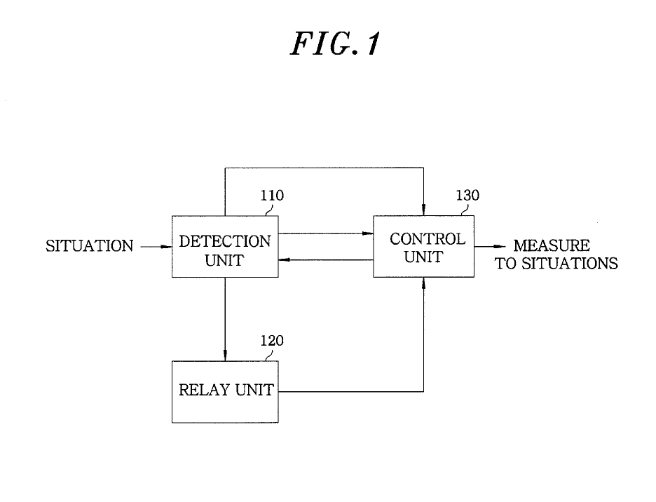

FIG. 1 shows a block diagram of an apparatus for detecting risky situations in accordance with an embodiment of the present invention.

The apparatus for detecting risky situations 100 includes a detection unit 110, a relay unit 120 and a control unit 130.

The detection unit 110 detects a risky situation in its surroundings, and notifies the relay unit 120 and/or the control unit 130 of the detected risky situation. Upon receipt of an additional request from the control unit 130, the detection unit 110 collects any additional risky situations in real time, and provides the collected risky situations to the control unit 130.

The detection of risky situations may be made through one or more techniques of following: an image analysis using image sensors, audio analysis using voice recognizers, high-frequency analysis using frequency generators, monitoring using NFC (near-field communications) device and UWB (ultra-wide band) device for short-range wireless communications), monitoring using devices for WAN (wide area network), and the like.

The risky situations detected by the detection unit 110 includes one or more the hazards such as an accidents, incidents, acts of traffic violence, and access controls that may occur in a physical space.

Alternatively, the detection unit 110 may notify the relay unit 120 of the detected risky situation and, in turn, the relay unit 120 may communicate to the control unit 130 of information on the risky situation received from the detection unit 110. To accomplish it, the relay unit 120 may includes a portable terminal that is capable of supporting short-distance communications or long-distance communications.

The control unit 130 determines if risky situations exist by analyzing the information on the risky situations delivered from the detection unit 110 or the information on the risky situations delivered via the relay unit 120. If it is determined that risky situations exist, the control unit 130 requests the detection unit 110 to obtain more details about the risky situations, and collects additional risky situation information in real time.

As previously discussed, the risky situation detection apparatus 100 enables to properly take countermeasure depending on a more accurately assessed risky situation in such a way that the detection unit 110, including image sensors and sound sensors, etc., detects risky situations by image analysis, audio analysis and so on in real time, and notifies the relay unit 120 and/or the control unit 130 of the detected risky situation, and the control unit 130 collects additional risky situation information in real time from the detection unit 110 to get more detailed risky situation information.

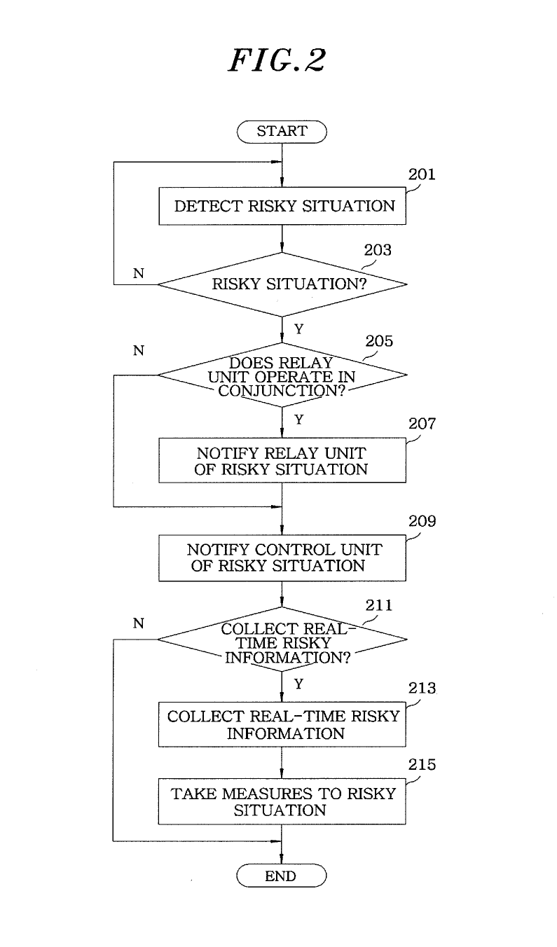

FIG. 2 illustrates a flowchart for explaining a method for detecting risky situations in accordance with an embodiment of the present invention.

The method includes detecting information on risky situations (step 201), assessing the risky situations by analyzing information on the risky situations (step 203), and taking measures to the assessed risky situations (steps 205 to 215).

In step S201, risky situations are detected through one or more techniques of following: an image analysis using image sensors, audio analysis using voice recognizers, high-frequency analysis using frequency generators, monitoring using NFC (near-field communications) device and UWB (ultra-wide band) device for short-range wireless communications), monitoring using devices for WAN (wide area network), and the like.

The risky situation includes one or more the hazards such as accidents, incidents, acts of traffic violence, and access controls that may occur in a physical space.

When risky situations are detected in step 203, the method proceeds to step 205. In step 205, the risky situations may be notified of the control unit 130 via the relay unit 120 as in step 207, or may be communicated directly to the control unit 130 without via the relay unit 120 as in step 209, depending on whether the relay unit 120 operates in conjunction with the apparatus of the present invention.

In step 211, upon receipt of the risky situations, the control unit 130 determines if the risky situations have actually occurred by analyzing the risky situations. As a result of the determination, if it is determined that the risky situations actually exist, and that the detection unit 110 has the ability of collecting detailed risky information, the control unit 130 additionally collects detailed real-time risky information through the detection unit 110 in step S213, and takes an appropriate measures to the risky based on the detailed real-time risky information in step 215. The above-described methods are repeatedly performed to detect other risky situations.

In accordance with the embodiment of the present invention, the instability of manual risky detection and measures taken thereto in the prior art can be eliminated by automatically detecting risky situations and actively reporting the risky situations, as well as minimizing damages caused by an risky situations by taking efficient measures to various risky situations.

While the invention has been shown and described with respect to the particular embodiments, it will be understood by those skilled in the art that various changes and modification may be made without departing the scope of the present invention as defined in the following claims.

What is claimed is:

1. An apparatus for detecting risky situations, the apparatus comprising:
a detection unit for detecting a risky situation and reporting the detected risky situation; and
a control unit for analyzing and assessing the risky situation reported from the detection unit to take measures to the assessed risky situation.

2. The apparatus of claim 1, wherein the detection of the risky situation is made through one or more techniques of following: an image analysis using image sensors, audio analysis using voice recognizers, high-frequency analysis using frequency generators, monitoring using NFC (near-field communications) device and UWB (ultra-wide band) device for short-range wireless communications), and monitoring using devices for WAN (wide area network).

3. The apparatus of claim 1, wherein the risky situation includes one or more the hazards including an accident, incident, act of traffic violence and access control.

4. The apparatus of claim 1, further comprising a relay unit for communicating the risky situation detected by the detection unit to the control unit,
wherein the relay unit has a capability of supporting short-distance communications or long-distance communications.

5. The apparatus of claim 4, wherein, if it is determined that the risky situation exists, the control unit is configured to request the detection unit to collect additional information on the risky situation in real time.

6. A method for detecting risky situations, the method comprising:
detecting an risky situation;
analyzing and assessing the detected risky situation; and
taking measures to the assessed risky situation.

7. The method of claim 6, wherein said detecting an risky situation includes detecting the risky situation through one or more techniques of following: an image analysis using image sensors, audio analysis using voice recognizers, high-frequency analysis using frequency generators, monitoring using NFC (near-field communications) device and UWB (ultra-wide band) device for short-range wireless communications), and monitoring using devices for WAN (wide area network).

8. The method of claim 6, wherein the risky situation includes one or more the hazards including an accident, incident, act of violence, and access control that may occur in a physical space.

9. The method of claim 6, further comprising communicating the detected risky situation,
wherein the detected risky situation is provided through short-range communications or wide-area network communications.

10. The method of claim 6, wherein said taking measures to the assessed risky situation includes requesting additional information on the risky situation to collect the additional information in real time.
